(19) United States
(12) Patent Application Publication
(10) Pub. No.: US 2009/0214900 A1
(43) Pub. Date: Aug. 27, 2009

(54) Fuel Cell System for Supplying Aircraft

(75) Inventors: Claus Hoffjann, Hamburg (DE); Harald Gründel, Hamburg (DE); Hans-Georg Schuldzig, Jork (DE); Hans-Jürgen Heinrich, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: AIRBUS DEUTSCHLAND GMBH, Hamburg (DE)

(21) Appl. No.: 12/084,081

(22) PCT Filed: Oct. 25, 2006
(86) PCT No.: PCT/EP2006/010287

§ 371 Date: Apr. 8, 2009

(30) Foreign Application Priority Data
Oct. 27, 2005 (DE) 10 2005 051 583.5

(51) Int. Cl. H01M 8/04; H01M 2/02; H01M 8/10; H01M 8/18

(52) U.S. Cl. 429/13; 429/34; 429/30; 429/26; 429/19

(57) ABSTRACT

A fuel cell system for aircraft with a passenger cabin comprises a fuel cell. The fuel cell comprises a first inlet connection, a first outlet connection, a cathode side and an anode side, wherein the first inlet connection is formed as the inlet connection of the cathode side and wherein the first outlet connection is formed as the outlet connection of the cathode side. In addition, the fuel cell system is designed in such a way that at the first inlet connection, a gas with a pressure is applied, which corresponds to an air pressure in the passenger machine.

This application claims the benefit of the filing date of German Patent Application No. 10 2005 051 583.5 filed Oct. 27, 1005, the disclosure of which is hereby incorporated herein by reference.

### FIELD OF THE INVENTION

The present invention provides a fuel cell system for supplying aircraft systems, a water supply system for aircraft, and a method for driving a fuel cell system of aircraft, in particular, a fuel cell system, which is also suited for supplying water.

### BACKGROUND OF THE INVENTION

In present day aircraft technology, assemblies for producing water on board of an aircraft using fuel cells are known. With such assemblies, a partial or complete integration of a water production unit, for example, in the form of one or more high-temperature fuel cells, can be provided in an aircraft engine, such that the combustion chambers of the aircraft engine are replaced completely or partially by the high-temperature fuel cells.

An energy supply unit on-board of an aircraft, for example, is disclosed in DE 19821952. This aircraft comprises a fuel cell, wherein for the air supply of the fuel cell, discharged or exhaust air of the aircraft climate control device or aircraft external air is used. In this regard, each fuel cell module is connected upstream of an air supply unit, which, in particular, comprises a compressor/expander unit for compressing the air supplied to the fuel cells, as well as for recycling energy from the heated air exiting from the fuel cells, an air filter, and a muffler.

### SUMMARY OF THE INVENTION

A need may exist to provide an efficient fuel cell system for supplying an aircraft, a water supply system for aircraft, an efficient method for operating a fuel cell system in an aircraft, and an aircraft with a fuel cell system.

This need may be fulfilled by a fuel cell system for an aircraft, a water supply system for an aircraft, a method for operating a fuel cell system in an aircraft and by an aircraft with a fuel cell system according to the features of the independent patent claims.

In an exemplary embodiment, a fuel cell system for aircraft with a passenger cabin comprises a fuel cell. The fuel cell comprises a first inlet connection, a first outlet connection, a cathode side and an anode side, wherein the first inlet connection is formed as an inlet connection of the cathode side and wherein the first outlet connection is formed as an outlet connection of the cathode side. Further, the fuel cell system is formed in such a way that at the first inlet connection, a gas with a pressure can be applied, which corresponds to an air pressure in the passenger machine or passenger cabin.

In another exemplary embodiment, a method for operating a fuel cell system in an aircraft, wherein the fuel cell system comprises a fuel cell, wherein the fuel cell comprises a first inlet connection, a first outlet connection, a cathode side and an anode side, wherein the first inlet connection is formed as an inlet connection of the cathode side and wherein the first outlet connection is formed as the outlet connection of the cathode side, includes applying a negative pressure on the outlet connection of the fuel cell. Further, the method includes suctioning of gas in the cathode side of the fuel cell by the negative pressure.

In another exemplary embodiment, a water supply system for an aircraft comprises a fuel cell system according to an exemplary embodiment of the invention, a fuel tank, a converter, and a heat exchanger, wherein the converter is configured as a DC/DC/AC converter, that is, as a direct current/direct current/alternating current converter, wherein the heat exchanger is configured in such a way that the heat produced by the fuel cell system can be conducted away by it and wherein the fuel tank is configured in such a way that by it, fuel is suppliable to the fuel cell system.

A basic idea of the present invention may be considered that a fuel cell system for an aircraft is provided, which operates without a compressor and/or blower for the air supply of the fuel cell system. The required air flow through the fuel cell may be drawn in completely through a negative pressure, which is applied at the outlet connection of the fuel cell, into the cathode side of the fuel cell. A distinctive feature may be that for producing a cathode-side required air flow, application of a negative pressure at an outlet connection of the fuel cell, that is at a discharge side of the fuel cell, is provided.

By the fuel cell system of the present invention, it may be possible to provide a fuel cell system for aircraft, which may be built in a particularly simple manner. Components of the fuel cell system also may be suited for integrating and/or assuming other functions of an aircraft and/or functions of systems of an aircraft.

A second basic idea of the invention may be viewed that it may be possible to eliminate a compressor, which may lead to weight savings and a reduction of the electrical auxiliary power or of the own electrical requirements, as well as to an increase of the reliability of the fuel cell system by elimination of electro-mechanical components.

A further advantage of the fuel cell system may be provided in the increase of the water recovery of the cathode discharge air by the applied negative pressure, wherein the condensation of water may be reduced within the fuel cell. Thus, it may be possible to operate the fuel cell at lower temperatures. With the constant temperature difference at a condenser of the fuel cell system, it may be possible to design the condenser to be smaller, since in the cathode discharge air, more water can be stored. Thus, the fuel cell system also may be suited for use in a water supply system in an aircraft.

A fuel cell system according to the present invention may fulfill at least one of the specifications that exists for a water generating system on a fuel cell basis in air travel. The fuel cell system of the present invention may be particularly suited for fulfilling basic specifications that will be described subsequently and may differ greatly from the current state of the art for water generating systems for mobile applications. Such specifications, for example, may lie in a robustness, that is, the water generating system must function reliably and without degradation under the environmental conditions on an aircraft, and/or in a resistance to cold, that is, the water generating systems must withstand these effects of cold in case the aircraft is parking in cold regions. Further specifications may lie in a cold-start capability, that is, systems must be capable of starting under conditions of frost within a short time, in a long lifetime, that is, systems must function for a defined minimum number of hours with a constant power, and/or a weight reduction, that is system weights are reduced to a minimum, which is necessary for reaching the functionality and serves for maintaining strength or stability specifications. In addition, further specifications may exist, such as a need for maintenance, that is the expense of maintenance, should be kept as small as possible, good accessibility, that is, maintenance hatches (access) or openings for maintaining should be easily accessible within the system, and/or purity, that is media currents and materials should be selected, such that the water obtained from the fuel cell system corresponds to appropriate regulations for drinking water.

Further objects, embodiments, and advantages of the invention are provided in the associated claims and dependent claims.

In the following, exemplary embodiments of the fuel cell system will be described in greater detail. The exemplary embodiments, which are described in connection with the fuel cell system, also apply to the water supply system for aircraft, the method for operating a fuel cell system, the aircraft with a fuel cell system and the use of a fuel cell system in an aircraft.

In another exemplary embodiment of the fuel cell system, the fuel cell system comprises a plurality of fuel cells.

In a further exemplary embodiment of the fuel cell system, the fuel cell is formed as a polymer electrolyte membrane fuel cell, as a direct methanol fuel cell, and/or as a phosphoric acid fuel cell. In particular, when a plurality of fuel cells are formed, individual fuel cells may be formed in different designs. Thus, mixed forms or any combinations of fuel cells may be present within a fuel cell system. For example, some fuel cells may be formed as polymer electrolyte membrane fuel cells (PEMFC), others as direct methanol fuel cells (DMFC), and/or as phosphoric acid fuel cells (PAFC).

In other words, such fuel cells or fuel cell systems may be suited for generating electrical energy and for production of drinking water, which alternatively, may contain as a base unit, the so-called stack, a PEMFC, a DMFC, or a PAFC or any combination of these technologies in one or in multiple stacks. The stack of the fuel cell systems may contain on the anode side a line for supplying with fuel. This fuel may comprise or consist of hydrogen, a hydrogen-containing reformate gas and/or methanol, depending on the type of fuel cell used and/or the combination used. In addition, the fuel cell stack may be provided on the cathode side with a supply line and a discharge line for air (oxygen) and water, respectively.

The fuel cell system can be equipped with an air filter, which is disposed in the fuel cell system in such a way that it filters cathode-side inlet air of the fuel cell. Thus, it may be assured that the fuel cell system furnishes an impeccable water quality and remains protected from dust and/or dirt particles, which could contaminate and/or clog elements of the fuel cell. Preferably, a differential pressure-poor air filter is used, which retain the noted air contents.

In another exemplary embodiment, the fuel cell system further comprises an outlet terminal, wherein the outlet terminal is configured in such a way that it can be coupled with the first outlet connection of the fuel cell and with the surrounding environment of the aircraft.

The provision of an outlet terminal, which can be coupled with the surrounding environment of the aircraft may be a particularly efficient way to make available a negative pressure or vacuum for the fuel cell, by which gas, for example, air and/or oxygen, can be suctioned into the cathode side of the fuel cell. This may apply, in particular, to the case when the aircraft is in flight, whereby a differential pressure between a pressure in the cabin and an outside pressure is provided

In a further exemplary embodiment, the fuel cell system further comprises a negative pressure system, wherein the negative pressure system or vacuum system is couplable with the first outlet connection of the fuel cell.

The provision of a negative pressure system or vacuum system may be a particularly efficient way to provide a negative pressure for the fuel cell, by which gas, for example, air and/or oxygen, can be suctioned into the cathode side of the fuel cell. A so-called vacuum system can be used as this type of negative pressure system, for example, which can be used also in the aircraft for disposal of waste water from the cabin. Such a negative pressure system may be particularly advantageous for producing a negative pressure when the aircraft is located on the ground or near ground level. Through this a differential pressure or pressure difference between the cabin pressure and the vacuum system of the aircraft can be produced. Contrary to a real vacuum the pressure difference may be merely about 500 hPa. A vacuum system may, as a rule, serve, as previously described, in an aircraft for disposal of excrements from the WCs. Near ground level or on the ground, the differential pressure between the vacuum system and the cabin pressure may be produced via a so-called vacuum generator at the waste tank of the vacuum system.

According to another exemplary embodiment, the fuel cell system further comprises a three-way valve, wherein the three-way valve can be coupled between the first outlet connection of the fuel cell, the negative pressure system, and the outlet terminal.

By using a three-way valve between the described components, it may be possible in a simple manner to conduct an efficient switching, depending on whether the aircraft is on the ground, near the ground, or at cruising altitude. On the ground, the three-way valve may be switched in such a way that the fuel cell can be provided with a differential pressure by the negative pressure system, whereas at cruising altitude, the three-way valve may be controlled in such a way that the differential pressure can be produced by the external air.

In a further exemplary embodiment, the plurality of fuel cells are formed as a stack. Also, multiple stacks can be formed, each of which comprising one or more fuel cells.

In an exemplary embodiment, the stack comprises a plurality of partial units, wherein each partial unit comprises a regulating valve, which is configured in such a way that a gas supply to the partial units is individually controllable. The partial or sub units each may be formed by a single fuel cell, for example, or each may be formed by a plurality of fuel cells.

By providing independent regulating valves per partial unit, it may be possible to control and/or regulate the air and/or oxygen supply for individual fuel cells and/or groups of fuel cells.

In another exemplary embodiment, the stack further comprises an end plate and/or the regulating valves are disposed in the end plate.

In a vivid way, it may therefore be possible to transfer specific functions of the fuel cell system, such as control valves of the supply and discharge lines of the gas or media in the end plates of the stack. These control valves may be comprised of individually controlled valves for each medium, which valves can be combined respectively in a valve block, wherein each individual valve supplies a specific region of the stack or alternatively, may supply an individual cell of the stack.

The advantage of this assembly may lie in a targeted or selective thermal control of the fuel cell stack by the individually controlled supply with media and the influence connected therewith on the fuel conversion, whereby a homogeneous heat profile in the stack may be achieved. This homogeneous heat profile may increase the live time of the stack and prevent local overheating and leakage caused thereby. By such an individual control, it also may be possible in an advantageous manner to equip certain regions in the stack with catalytic heating elements. With such a design, it may be possible to heat up a stack at low temperatures or to heat to operating temperature, whereby possibly, a cold start capability may be improved and/or protection against freezing may be achieved.

The design of the end plate also can be viewed as an independent partial aspect of the invention, that is, as a partial aspect which is independent of the design of the above-described fuel cell system. That is, an end plate for a fuel cell stack is provided, wherein the end plate comprises control valves and/or regulating valves, which are configured in such a way that by them, an air and/or oxygen supply is controllable or regulatable individually for individual fuel cells and/or groups of fuel cells in the fuel cell stack.

In a further exemplary embodiment, the end plate is made from a material with a density of less than 1 kg/dm³. As the material, for example, aluminium foam can be used.

According to an embodiment of the present invention, by using light materials, it may be possible to replace the end plates that are used in common fuel cell stacks, which generally are made from rolled, cast, or forged aluminium plates, wherein the plate thickness and the plate weight are reduced by milling out in a rib structure. According to an embodiment of the invention, a material with a minimal specific weight may be used, whereby a weight savings may be possible.

In a further exemplary embodiment, the end plate is configured in such a way that the stack is braceable (verspannbar) by tensioning belts.

A bracing capability of the stack may be provided by shaping of the end plate. The shaping may take place in this regard, such that in a primarily load plane, the greatest rigidity of the end plate is provided, whereby bracing (Verspannung) may be made possible. By such a bracing capability, an efficient possibility may be provided for fixing the fuel cells. This may be possible for the fuel cells under one another as well as with reference to fixing of the fuel cell stacks within the aircraft. By the bracing, it may also be possible to protect the fuel cell stacks against the effects of the pressure of the media (gas) occurring in their interiors, wherein this bracing also may function as a sealing of the stacks against leakage of the media. In this regard, one or more tensioning belts can be placed around the stack in the longitudinal direction over the end plates with tensioning locks or tension jacks. In this manner, it may be possible by tensioning of the tensioning belts to apply pressure forces, which serve to hold together the stack.

In another exemplary embodiment, the stack comprises inner guide elements.

The provision of inner guide elements within the stack may be an efficient way to prevent shifting or slipping of the cells of a stack against one another and/or individual elements of a cell against the elements surrounding it.

In a further exemplary embodiment, the fuel cell system further comprises a tie rod or tension rod, wherein the tie rod is configured in such a way that the tie rod, the stack is braceable. In an advantageous manner, the tie rod may comprise carbon fibre-reinforced plastic as its material

The provision of a tie rode can be an alternative or cumulative design to belt-tensioning, in order to assure bracing of the stack.

By the use of a carbon fibre-reinforced tie rod, it may be possible to avoid the embodiment known in the state of the art of tensioning with tie rods, which brace the individual plates and membranes of the stack in the longitudinal direction. These tie rods are embodied in the state of the art as threaded rods with nuts and plate springs or turn screws. By using carbon fibre-reinforced tie rods, a significant weight savings may be possible. The carbon fibres may be used in this regard, such that they can impinge the stack in the longitudinal direction with a pressure force on the end plates via two opposed tensioning elements.

The design of the tie rod also can be viewed as an independent partial aspect of the present invention, that is, as a partial aspect which is independent of the embodiments of the above-described fuel cell system. That is, a tie rod for a fuel cell stack is provided, wherein the tie rod is configured in such a way that by the tie rod, the stack is braceable, wherein the tie rod comprises carbon fibre-reinforced plastic as its material.

In a further exemplary embodiment, the fuel cell system further comprises a first exhaust air valve, wherein the first exhaust air valve is coupled to the first outlet connection.

Thus, it may be possible to provide an efficient differential pressure control for the cathode side of the fuel cell.

In another exemplary embodiment, the fuel cell system comprises a second exhaust air valve and the fuel cell comprises a second outlet connection, which second outlet connection is formed as an outlet connection of the anode side. Further, the second exhaust valve is coupled to the second outlet connection.

By such a design, it may be possible to provide also an efficient differential pressure control for the anode side of the fuel cell.

In a further exemplary embodiment, the fuel cell system further comprises a heating element, wherein the heating element is configured in such a way that by the heating element, the fuel cell is heatable. Preferably, the stack can comprise a plurality of heating elements, wherein the heating elements are integrated between individual fuel cells. In particular, the heating elements can be formed as catalytic heating elements.

In other words, individually controllable catalytic heating elements can be integrated and distributed between individual fuel cell elements. These heating elements may make it possible that upon impingement with hydrogen and air and/or oxygen through the catalytic reaction, with which hydrogen and oxygen are converted into water, that amount of heat can be produced, which may be required in order to heat the stack uniformly to operating temperature, and/or to prevent freezing of the fuel cell system by freezing through of the aircraft.

In another exemplary embodiment, the fuel cell comprises a bipolar plate, the bipolar plate comprising as its material a conductive plastic. Preferably, the bipolar plate comprise a first main side, a second main side, and a plurality of channels, wherein a first portion of the plurality of channels is arranged on the first main side. Further, a second portion of the plurality of channels is disposed on the second main side in such a way that channels of the first portion of the plurality of channels do not face channels of the second portion of plurality of channels.

In a vivid way, such an arrangement of the channels can be described as an alternating arrangement of the channels, that is, when one channel or convexity is located on one side of the bipolar plate, then no channel is located on the other, opposite side. With such an arrangement, it may be possible to hold a material usage for the bipolar plate to a minimum or to minimize it, whereby it may be possible to save weight.

As a material for the bipolar plates, plastic with a graphite portion of approximately 80% is suitable. In contrast to bipolar plates made of steel with a specific weight of approximately 7.9 kg/dm³, these plastic bipolar plates may have a specific weight of 2.2 kg/dm³. These types of plastic can be used for making a bipolar plate, wherein the bipolar plates made therefrom can be made in an injection moulding process and therefore, may be designed particularly thin and cost-effectively. A further weight reduction may be achieved by the arrangement of the media-guiding channels in such a was that opposed channels on the same bipolar plate are displaced respectively to one another, such that the most minimal material use may be possible.

The design of the bipolar plate also can be viewed as an independent partial aspect of the present invention, that is, as a partial aspect which is independent of the embodiments of the above-described fuel cell system. That is, a fuel cell is provided which comprises a bipolar plate, which bipolar plate comprises as a material a conductive plastic. The bipolar plate comprises a first main side, a second main side, and a plurality of channels, wherein a first portion of the plurality of channels are arranged on the first main side. In addition, a second portion of the plurality of channels is arranged on the second main side in such a way that the channels of the first portion of the plurality of channels do not face the channels of the second portion of the plurality of channels.

Particularly advantageously, a fuel cell system according to the present invention may be used in an aircraft.

According to an exemplary embodiment of the present invention, the operating point of the fuel cell is selected in such a way that an emitted heat of the fuel cell system is minimal, that is, for example, an optimizing with reference to the emitted heat is performed in order to obtain an operating point of the fuel cell, which operating point satisfy specifications of minimal emitted heat.

By such optimization, it may be possible to hold a heat output of the fuel cell as minimal as possible, which fuel cell releases not only electrical energy with the conversion of hydrogen (2H₂) and oxygen (O₂) to water (2H₂O) but also heat.

In a further exemplary embodiment, an operating point of the water supply system is optimized with reference to a total weight of the water supply system.

A possible optimization with regard to the operating point, in particular, of an operating point with regard to a voltage released by the fuel cell, of the water supply system can be performed, for example, by a possibly iterative use of the following formula.

$${G}_{System} = {GS}_{0} \cdot \frac{{j}_{0} ( {u}_{0} ) \cdot {u}_{0}}{{j}_{1} ( {u}_{1} ) \cdot {u}_{1}} + {GT}_{0} \cdot \frac{{u}_{0}}{{u}_{1}} + ( {GW}_{0} + {GP}_{0} ) \cdot \frac{( {U}_{th} - {u}_{1} ) \cdot {j}_{0} ( {u}_{1} )}{( {U}_{th} - {u}_{0} ) \cdot {j}_{0} ( {u}_{0} )} + {GK}_{o} + \frac{{j}_{0} ( {u}_{0} ) \cdot {u}_{0}}{{j}_{1} ( {u}_{1} ) \cdot {u}_{1}} ,$$

wherein:
GS₀=stack weight of the non-optimized assembly (water supply system),
GT₀=fuel and tank weight of the non-optimized assembly,
GW₀=weight of the heat exchanger of the non-optimized assembly,
GP₀=weight of the pumps of the non-optimized assembly,
GK₀=converter weight of the non-optimized assembly,
u₀=cell voltage of the basic stack, i.e., of the stack of the non-optimized assembly,
j₀=current density of the base stack, i.e., of the stack of the non-optimized assembly,
u₁=cell voltage of the stack at a new operating point,
j₁=current density of the stack at a new operating point.

By such a formula, it may be possible to determine the operating point of a weight-optimized fuel cell system in a water supply system, wherein particular circumstances with regard to stack size, stack number, and performance data apply.

With such a selection of the optimal fuel cell parameters, the following mathematical interrelation may be considered. On the one hand, a linear interrelation between cell voltage u(j) und current density j according to u(j)=u′−r*j, wherein r represents the increase of the voltage-current density curve. From this, the following relation for a constant electrical stack power may be derived:

For the stack weight, the following applies:

G₁/G₀=(j₀(u₀)*u₀)/(j₁(u₁)*u₁),

wherein
u₀=cell voltage of the base stack, i.e., of the stack of the non-optimized assembly,
j₀=current density of the base stack, i.e., of the stack of the non-optimized assembly,
u₁,j₁=cell voltage and current density of the stack at a new operating point with u₁>u₀ und j(u₁)<j₀(u₀), and
G₁,G₀=weight of the new stack and the base stack.

From this, it arises that with a stack power held constantly, the stack weight increases with increasing voltage (G₁>G₀), since with increasing voltage u₁ the current density j₁ according to the u-j-characteristic line decreases and is r=ΔU/Δj<−0.5. In other words: if one increases the voltage at ΔU, then the current density Δj decreases at a factor greater than 2*ΔU. From this, it follows that the cell surface must be increased in order to hold constant the stack power, and therewith, the total weight increases.

For the hydrogen and oxygen consumption, the following applies:

The electrical efficiency TI is increased with an increase of the voltage from u₀ to u₁ (u₁>u₀) according to:

η₁/η₀=u₁/u₀,

(for η₁ new stack, η₀ basic stack)
when u₁ is greater than u₀. From this, a reduction of the hydrogen consumption may result according to:

m₁/m₀=η₀/η₁=u₀/u₁,

(for m₁ consumption with a new stack, m₀ for basic stack) and therewith, also a reduction of the aerial oxygen.

For heat production, the following applies:

An increase of the electric efficiency TI may result in a minor heat production and thus, heat given off Q per unit time is reduced (for Q₁<Q₀) according to:

Q₁/Q₀=[(Uₜₕ−u₁)*j₀(u₁)]/[(Uₜₕ−u₀)*j₀(u₀)],

wherein Uₜₕ is the so-called thermal equilibrium voltage.

With regard to the heat exchanger (heat transferer) and pumps, the following applies:

By the reduced heat production, the surfaces of the heat exchanger, and as a result, its weight, may be reduced (for G₁<G₀) as follows:

G₁/G₀=Q₁/Q₀=A₁/A₀,

(for A₀ surface of the base stack and A₁ surface of the optimized stack). In addition, in the same amount, also the heat capacity flow and therewith, the necessary pump power for the cooling medium may reduce, which may mean a reduction of parasitic electrical consumption and weight.

With regard to the converter, the following applies:

With a constant cell surface, a number of required cells increases according to:

N₁/N₀=(j₁(u₁)*u₁)/(j₀(u₀)*u₀),

(for N₀ number of cells in the base stack and N₁ the number of cells in new stacks), since:

P=const.=u*N*j(u)*A=U_{S}*j(u)*A=U_{S}*I_{S},

wherein P is the electrical power of the stack and A the area of the stack. With a reduction of the stack current I_{S} and an increase of the stack voltage U_{S} also the weight of DC/DC/AC-converter may be reduced and its efficiency increased.

Thus, by an optimization, it may be possible to reduce the weight of the fuel cell system and the water supply system, since the enlargement of the stack, which with the selection of the above-described operating point is unavoidable, due to a reduction of the fuel gas required for the same power, may affect the use of a smaller cooler and smaller heat exchanger, as well as a smaller electrical converter.

In order to reduce the weight of a fuel cell system, it may be required to decrease essentially the weight of the stack. According to the present invention, this may occur in the present assembly by the use of conductive plastic materials as bipolar plates, their particular specification for weight reduction, by the manner of the bracing of the stack, and by the use of light-weight end plates, for example, by glass fibre-reinforced carbon or plastics. In addition, the system weight may be reduced by the use of plastics in the periphery of the fuel cell stack, such as for example, ducts, fittings, couplings, and valves.

With a water supply system, materials are preferably selected for the water-guiding components, which on the one hand are resistant to demineralized water, which for example, has a conductivity of κ of approximately 20 μS/m, und on the other hand, also are suited for the use in drinking water systems. This also applies for the design of the bipolar plates, the end plates, and the membranes on the cathode side of the fuel cell.

Further, for the ducts of the periphery of the water supply system, preferably materials are used, which are as light as possible, for example, plastic pipes with nano-coating or glass coating. These pipes may excel, on the one hand, because of its small specific weight and on the other hand by particular properties relative to hydrogen on the anode side and demineralized water on the cathode side. Preferably, the pipes used on the anode side have a high hydrogen impermeability, while the pipes used on the cathode side preferably have a high resistance against demineralized water and in addition, preferably fulfill the international proposed norms for lines that carry drinking water.

One aspect of the present invention may be seen in that a fuel cell system for an aircraft is provided, which consists of or comprises one or more fuel cell stacks, wherein these stacks can be of the type polymer electrolyte membrane fuel cell (PEMFC), direct methanol fuel cell (DMFC), or phosphoric acid fuel cell (PAFC) or can represent a mixture of these. In this regard, the stack or stacks are impinged on the cathode side with air and/or oxygen, wherein for the flow-through of the cathode side, the pressure between a cabin-sided supply lying at a higher pressure level and a discharge line lying at a lower pressure level in the atmosphere surrounding the aircraft is used. The differential pressure between the cathode side applied to the discharge line can be produced, in that with the same pressure conditions between the cabin pressure and the outside pressure on the discharge side, for reducing the pressure level, a vacuum system is used, wherein this vacuum system also can be used for removing waste water from the cabin of the aircraft. In particular, specific regions of the stack comprised of multiple cells or individual cells of the stack, respectively, can have an individual air or oxygen supply line and these supply lines are individually controllable via regulating valves. Preferably, these regulating valves are integrated in an end plate of the stack.

Preferably, according to this aspect, distributed between individual fuel cell elements individually controllable catalytic heating elements are integrated, by which catalytic reactions, in which hydrogen and oxygen are converted to water, produce heat quantity, which is necessary in order to heat the stack uniformly to the operating temperature, or to prevent freezing of the fuel cell system when a freezing-through of the aircraft occurs. The bipolar plates used in the fuel cell stack can comprise conductive plastic, wherein the arrangement of the media-guiding channels on both sides of the bipolar plate is embodied to be displaced, such that the material use is minimized. Preferably, the end plates are made from a material with a density of less than 1 kg/dm³, such as for example, from aluminium foam. In addition, the end plates can be formed, such that the stack can be braced with tensioning belts, wherein with a stack braced with tensioning belts, this is preferably provided with inner guide elements, which prevent slipping of the cells against one another or of the individual elements of one cell against the elements surrounding it. Alternatively, the stack can be equipped with tie rods made of carbon fibre-reinforced plastic for bracing. Optionally, a differential pressure regulation of the fuel cell system (on cathode and/or on cathode and anode side) is realized via a control of the “outflow valves”.

It should be noted that the features or steps, which have been described with reference to one of the above embodiments or with reference to one of the above aspects and/or partial aspects can be used independently and/or in combination with other features or steps of other above-described embodiments or aspects and/or partial aspects.

Next, the invention will be described in greater detail with regard to exemplary embodiments with reference to the drawings.

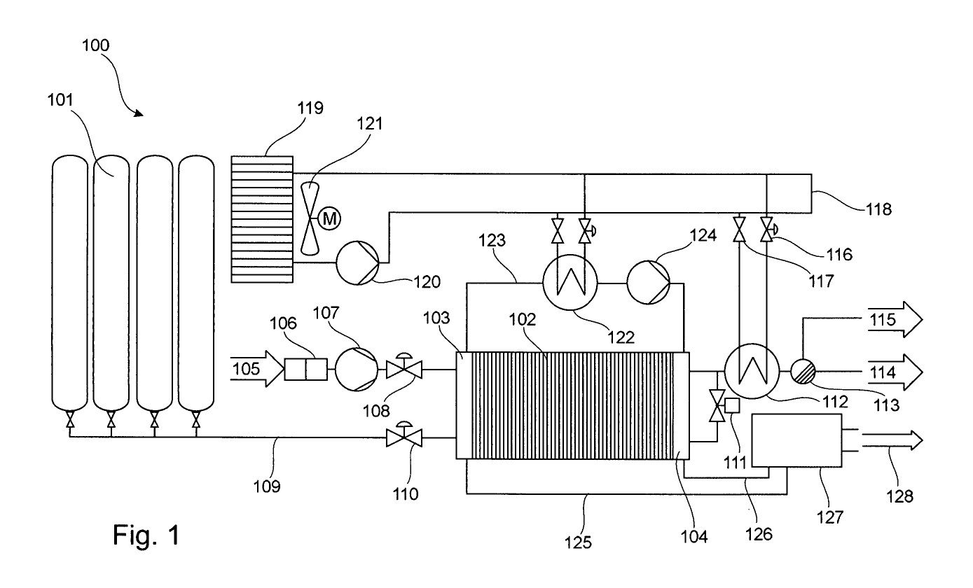

FIG. 1 shows a schematic representation of a fuel cell system for supplying electrical consumers and for water supply of an aircraft.

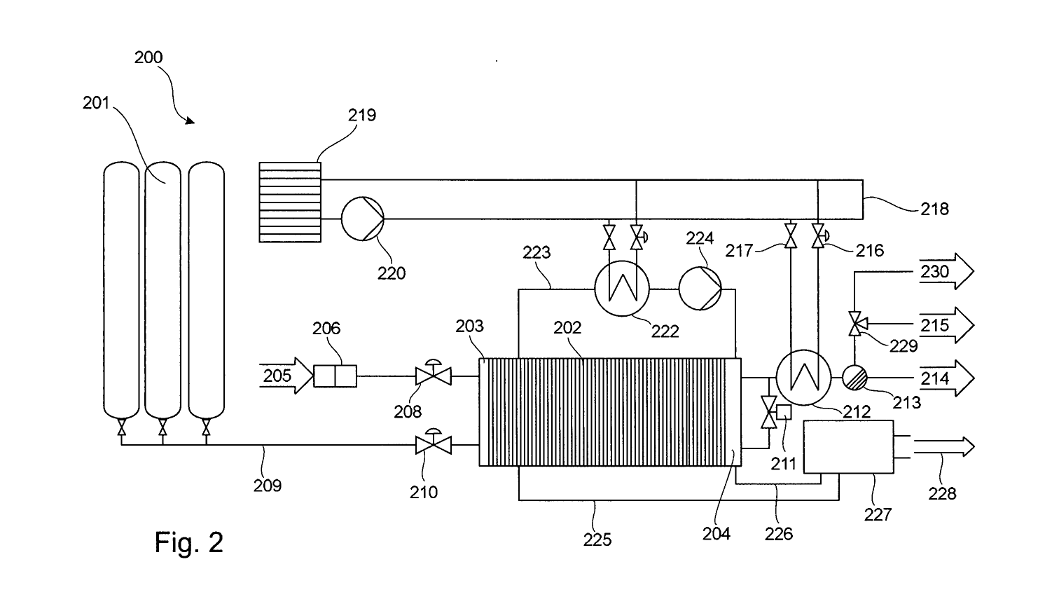

FIG. 2 shows a schematic representation of a fuel cell system for supplying electrical consumers and for water supply of an aircraft according to an exemplary embodiment of the invention.

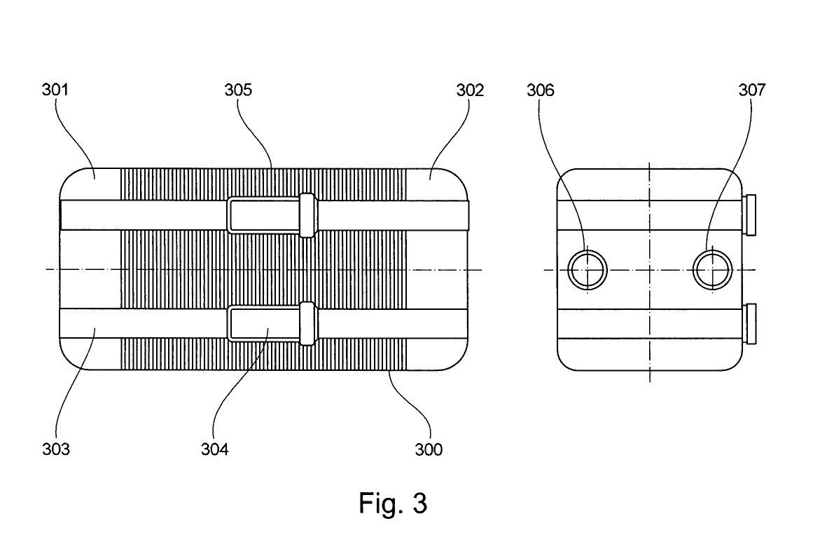

FIG. 3 shows a schematic representation of a braced stack.

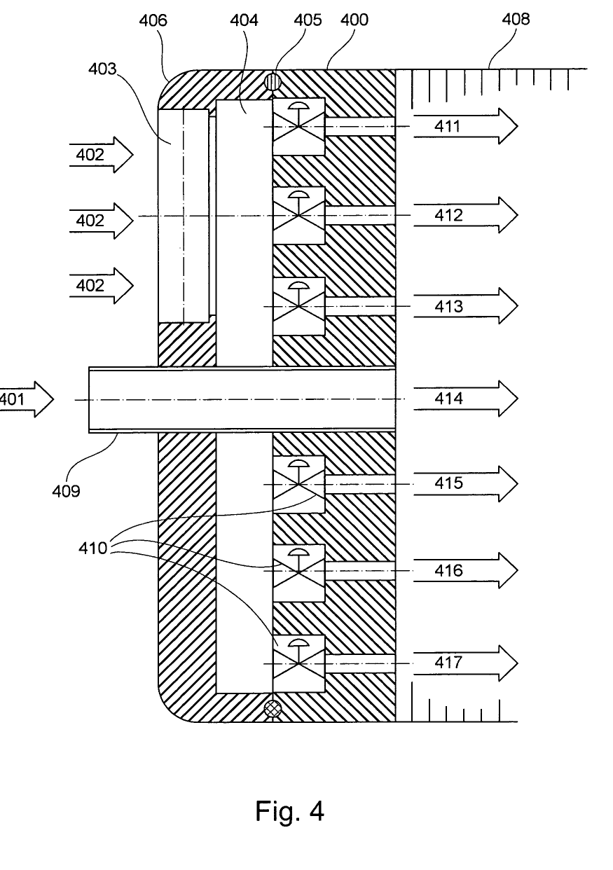

FIG. 4 shows a schematic sectional representation of an end plate with valves.

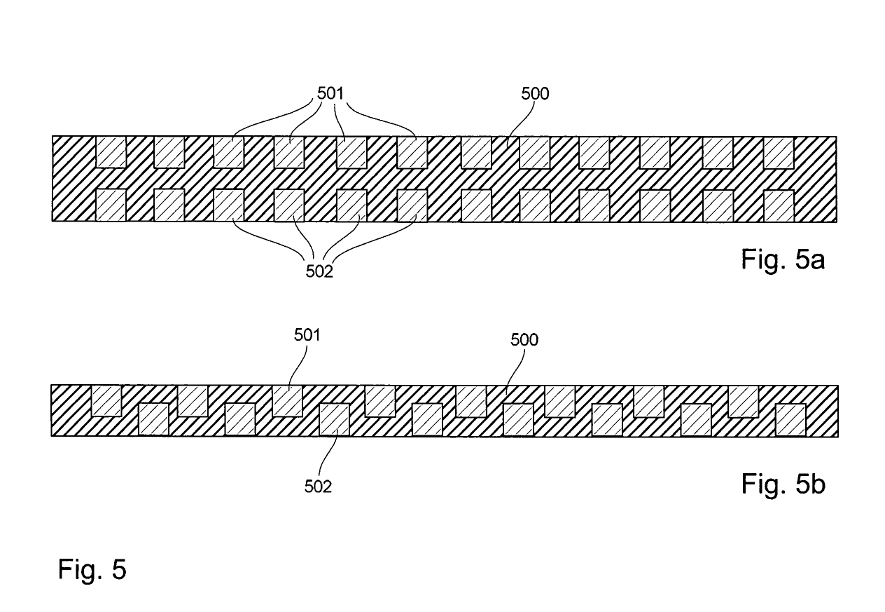

FIG. 5 shows a schematic sectional representation of bipolar plates.

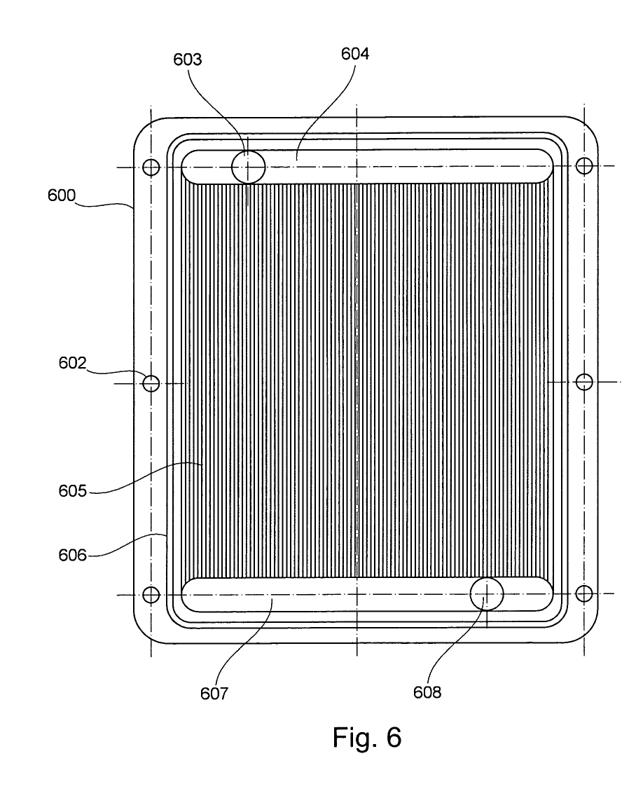

FIG. 6 shows a schematic representation in plan view of a bipolar plate.

Similar or identical components are provided in the different figures with similar or identical reference signs.

FIG. 1 shows a schematic representation of a fuel cell system for supplying electrical consumers and for water supply of an aircraft. The fuel cell system 100 comprises a fuel tank 101 for fuel supply and a fuel cell stack 102. The fuel cell stack 102 comprises a supply-side end plate 102 and a discharge-side end plate 104. The fuel cell stack 102 is supplied with supply air via a first supply line 105, which comprises an air filter 106, a compressor 107, and a first valve 108, for flow regulation of a cathode-side of the fuel cell stack 102. Further, the fuel cell stack 102 is provided with fuel via a second supply line 109 from the fuel tank 101 on the anode side. The second supply line comprises a second valve 110, by which a flow regulation of the anode side is performable.

The discharge-side end plate 104 is coupled via a third valve 111, a so-called purge valve, with a condenser 112. The condenser 112 is coupled with a condensate drain 113, by which condensed water can be discharged via a first connection 114 to a water system. In addition, the condensate drain 113 is coupled with a second connection 115 to an external pressure level, that is, to the external air outside of the aircraft. The condenser 112 is further coupled via a third valve 116 and a fourth valve 117 to a cooling circuit 118. The cooling circuit 118 comprises an external air cooler 119 and a secondary cool water pump 120, by which a coolant can be pumped through the circuit 118. In addition, the cooling circuit 118 comprises a cooling blower 121.

In addition, the cooling circuit 118 is coupled with a heat exchanger 122, which is used in order to cool the fuel cell stack 102. In this connection, an additional cooling circuit 123, of which the heat exchanger 122 is a part, comprises a primary cool water pump.

Furthermore, the fuel cell stack 102 is coupled via electrically conductive lines 125 and 126 with a voltage converter 127, which is further coupled with an electrical network 128 of the aircraft.

FIG. 2 shows a schematic representation of a fuel cell for supplying electrical consumers and for water supply of an aircraft according to an embodiment of the invention. The fuel cell system 200 comprises a fuel cell tank 201 for fuel supply and a fuel cell stack 202. The fuel cell stack 202 comprises a supply line-side end plate 203 and a discharge line-side end plate 204. The fuel cell stack 202 is provided with supply air via a first supply line 205, which comprises an air filter 206 and a first valve 208 for flow regulation of a cathode side of the fuel cell stack 202. In addition, the fuel cell stack 202 is provided with fuel via a second supply line 209 from the fuel tank 201 on the anode side. The second supply line comprises a second valve 210, by which a flow regulation of the anode side is performable.

The discharge line-side end plate 204 is coupled via a third valve 211, a so-called purge valve, with a condenser 212. The condenser 212 is coupled with a condensate drain 213, by which condensed water can be conducted via a first connection 214 to a water system. Further, the condensate drain 213 is coupled to a three-way valve 229, which is coupled with a second connection 215 at an external pressure level, that is, to the external air outside of the aircraft. Further, the three-way valve 229 is coupled with a third connection 230 to a vacuum system of the aircraft. The condenser 212 further is connected via a third valve 216 and a fourth valve 217 to a cooling circuit 218. The cooling circuit 218 is coupled with an external air cooler 219 and with a secondary cool water pump 220, by which a coolant can be pumped through the cooling circuit 218.

Furthermore, the cooling circuit 218 is coupled with a heat exchanger 222, which is used for cooling the fuel cell stack 202. In this connection, an additional cooling circuit 223, of which the heat exchanger 222 is a part, comprises a primary cool water pump 224.

Furthermore, the fuel cell stack 202 is coupled via electrically conductive lines 225 and 226 with a voltage converter 227, which is further coupled with an electrical network 228 of the aircraft.

The embodiment according to FIG. 2 is characterized in that it does not have a compressor, by which a cathode-side supply air is brought to a pressure, which lies above the cabin pressure. The cathode-side supply air is solely suctioned by a negative pressure, to which the discharge air-side of the fuel cell stack is exposed to, through the cathode side of the fuel cell. In this connection, on the one hand, the external air is used, which provides a negative pressure during a flight, which corresponds to the external pressure at cruising altitude. On the other hand, on the ground or at a lower altitude, a negative pressure or vacuum system can be used, which provides a pressure drop with reference to the cabin pressure. Switching between these two alternatives can be done by the three-way valve.

FIG. 3 shows a schematic representation of a braced stack 300. The stack 300 comprises a supply line-side end plate 301 and a discharge line-side end plate 301. In addition, in FIG. 3, a tensioning belt 303, comprising a tensioning lock 304, is shown, by which tensioning belt 303, the stack 300 can be braced. In FIG. 3, also individual fuel cells 305 of the fuel cell stack 300 are shown as perpendicular lines. On the left side of FIG. 3, a view perpendicular to the longitudinal axis of the fuel cell is shown, in which a first discharge line 306 for air and/or oxygen and a second discharge line 307 for H₂-purging is shown.

FIG. 4 shows a schematic sectional representation of an end plate with valves. The end plate 400 comprises a first supply line 401 for hydrogen and multiple second lines 402 for air and/or oxygen. In addition, the end plate 400 comprises a filter 403, for example, a screw-in filter, by which air and/or the oxygen, which is conducted through the second lines 402, can be filtered. Downstream of the filter 403, the end plate 400 comprises a distributor or manifold 404, by which the air and/or the oxygen can be distributed. In addition, the end plate 400 comprises a face plate 406. The end plate 400 can be formed as one piece or integral with this face plate 406 or the face plate 406 can be embodied as a separate component and can be connectable to the end plate 400, wherein than a sealing 405 between the face plate 406 and the end plate 400 is provided. Further, in FIG. 4, a part of a fuel cell stack 408 is still shown, to which the end plate 400 is attached. By a pipe 409 shown schematically in FIG. 4, the fuel cell stack can be supplied with hydrogen. In addition, the end plate 400 comprises a plurality of control valves 410, by which control valves an air and/or oxygen supply can be controlled and/or regulated. The supply lines for the air/oxygen supply are designated in FIG. 4 schematically by the arrows 411 through 417, wherein the arrow 411 represents the air/oxygen supply for the cells X through Xₐ, the arrow 412 represents the air/oxygen supply for the cells Xₐ₊₁ through X_{b}, the arrow 413 represents the air/oxygen supply for the cells X_{b+1} through X_{c}, the arrow 414 represents the air/oxygen supply for the cells X_{c+1} through X_{d}, the arrow 415 represents the air/oxygen supply for the cells X_{d+1} through Xₑ, the arrow 416 represents the air/oxygen supply for the cells Xₑ₊₁ through X_{f} and the arrow 417 represents the air/oxygen supply for the cells X_{f+1} through X_{g}.

FIG. 5 shows a schematic sectional representation of bipolar plates 500. In the upper FIG. 5a, a bipolar plate 500 is shown, which comprises gas channels 501 on a first side and comprises gas channels 502 on a second side opposite to the first side. In FIG. 5a, each gas channel 501 on the first side faces a respective gas channel 502. In the lower FIG. 5b, a second bipolar plate 500 is shown, which comprises gas channels 501 on a first side and on a second side opposite to the first side comprises gas channels 502. In FIG. 5b, a respective gas channel 501 on the first side does not face a gas channel 502. In other words, the gas channels 501 and 502 alternate along the bipolar plate, they are alternatingly arranged. In this manner, it is possible to reduce the thickness of the bipolar plate, whereby it may be possible to reduce a weight of the bipolar plate.

FIG. 6 shows a schematic representation in plan view of a bipolar plate 600. The bipolar plate 600 comprises a bore 602 for a guide pin. Further, a gas supply line 603 and a supply-side gas distributor 604 are arranged in the bipolar plate 600. In FIG. 6, a so-called flow field 605, through which the supplied gas is conducted, and a seal 606 are shown. Further, the bipolar plate 600 comprises a discharge line-side gas collecting device 607 and a gas discharge line 608.

In addition, it should be noted that “comprising” does not exclude other elements or steps and “a” or “one” does not exclude a plurality. Furthermore, it should be noted that the features or steps, which were described with reference to one of the above embodiments also can be used in combination with other features or steps of other above-described embodiments. Reference signs in the claims are not to be viewed as limitations.

1. An aircraft with a passenger cabin and a fuel cell system, wherein the fuel cell system comprises:
a fuel cell, wherein the fuel cell comprises:
a first inlet connection;
a first outlet connection;
a cathode side; and
an anode side;
wherein the first inlet connection is formed as an inlet connection of the cathode side;
wherein the first outlet connection is formed as an outlet connection of the cathode side; and
wherein the fuel cell system is designed in such a way that at the first inlet connection, a gas with a pressure is applyable, which corresponds with an air pressure in the passenger cabin.

2. An aircraft as claimed in claim 1, wherein the fuel cell system comprises a plurality of fuel cells.

3. An aircraft as claimed in claim 1, wherein the fuel cell is formed as at least a polymer electrolyte membrane fuel cell, as a direct methanol fuel cell, and/or as a phosphoric acid fuel cell.

4. An aircraft as claimed in claim 1, wherein the fuel cell system further comprises:
an outlet terminal,
wherein the outlet terminal is designed in such a way that it is coupleable with the first outlet connection of the fuel cell and with a surrounding environment of the aircraft.

5. An aircraft as claimed in claim 1, wherein the fuel cell system further comprises:
a negative pressure system,
wherein the negative pressure system is couplable with the first outlet connection of the fuel cell.

6. An aircraft as claimed in claim 5, wherein the fuel cell system further comprises:
a three-way valve,
wherein the three-way valve is couplable between the first outlet connection of the fuel cell, the negative pressure system, and the outlet terminal.

7. An aircraft as claimed in claim 2, wherein the plurality of fuel cells is formed as a stack.

8. An aircraft as claimed in claim 7,
wherein the stack comprises a plurality of partial units, and
wherein each partial unit comprises a regulating valve, such that a gas supply to the partial units is individually controllable.

9. An aircraft as claimed in claim 8,
wherein the stack further comprises an end plate; and
wherein the regulating valves are arranged in the end plate.

10. An aircraft as claimed in claim 9, wherein the end plate is made from a material with a density of less than 1 kg/dm³.

11. An aircraft as claimed in claim 9, wherein the end plate is designed in such a way that the stack can be braced by tensioning belts.

12. An aircraft as claimed in claim 7, wherein the stack comprises inner guide elements.

13. An aircraft as claimed in claim 7, wherein the fuel cell system further comprises a tie rod, and wherein the tie rod is designed in such a way that by the tie rod, the stack is braceable.

14. An aircraft as claimed in claim 13, wherein the tie rod comprises as a material carbon-fibre reinforced plastic.

15. An aircraft as claimed in claim 1, wherein the fuel cell system further comprises:
a first exhaust air valve, and
wherein the first exhaust air valve is coupled to the first outlet connection.

16. An aircraft as claimed in claim 1, wherein the fuel cell system comprises:
a second exhaust air valve, and
wherein the fuel cell further comprises:
a second outlet connection, which is formed as an outlet connection of the anode side, and
wherein the second air discharge valve is coupled to the second outlet connection.

17. An aircraft as claimed in claim 1, wherein the fuel cell system further comprises:
a heating element, and
wherein the heating element is designed in such a way that by the heating element, the fuel cell is heatable.

18. An aircraft as claimed in claim 7,
wherein the stack comprises a plurality of heating elements; and
wherein the heating elements are integrated between individual fuel cells.

19. An aircraft as claimed in claim 17, wherein the heating elements are formed as catalytic heating elements.

20. An aircraft as claimed in claim 1, wherein the fuel cell comprises a bipolar plate, which bipolar plate comprises as a material a conductive plastic.

21. An aircraft as claimed in claim 20, wherein the bipolar plate comprises:
a first main side;
a second main side; and
a plurality of channels,
wherein a first portion of the plurality of channels is arranged on the first main side, and
wherein a second portion of the plurality of channels is arranged on the second main side, in such a way that the channels of the first portion of the plurality of channels do not face channels of the second portion of the plurality of channels.

22. An aircraft comprising a water supply system, the water supply system comprising:
a fuel cell system, the fuel cell system comprising:
a fuel cell, wherein the fuel cell comprises:
a first inlet connection;
a first outlet connection;
a cathode side; and
an anode side;
wherein the first inlet connection is formed as an inlet connection of the cathode side;
wherein the first outlet connection is formed as an outlet connection of the cathode side; and
wherein the fuel cell system is designed in such a way that at the first inlet connection, a gas with a pressure is applyable, which corresponds with an air pressure in the passenger cabin;
wherein the water supply system further comprises:
a fuel tank;
a converter; and
a heat exchanger,
wherein the converter is designed as a DC/DC/AC converter;
wherein the heat exchanger is designed in such a way that by it, heat produced by the fuel cell system can be conducted away; and
wherein the fuel tank is designed in such a way that by it, fuel can be supplied to the fuel cell system.

23. An aircraft as claimed in claim 22, wherein an operating point of the water supply system is optimized with reference to a total weight of the water supply system.

24. A method for operating a fuel cell system in an aircraft with a passenger cabin, wherein the fuel cell system comprises a fuel cell, wherein the fuel cell comprises a first inlet connection, a first outlet connection, a cathode side and an anode side, wherein the first inlet connection is formed as the inlet connection of the cathode side and wherein the first outlet connection is formed as the outlet connection of the cathode side, wherein the method comprises:
applying, at the first inlet connection, a gas with a pressure, which pressure corresponds with an air pressure in the passenger cabin;
placing a negative pressure on the outlet connection of the fuel cell; and
suctioning gas into the cathode side of the fuel cell by the negative pressure.

25. (canceled)

26. (canceled)
